(19) United States
(12) Patent Application Publication
(10) Pub. No.: US 2007/0181148 A1
(43) Pub. Date: Aug. 9, 2007

(54) Wafer cleaning apparatus and related method

(76) Inventors: Min-Sang Yun, Yongin-si (KR); Kwon Son, Suwon-si (KR); Jae-Hyung Jung, Yongin-si (KR); Hee-Chan Jung, Hwaseong-si (KR); Ki-Ryong Choi, Suwon-si (KR); Byung-Joo Park, Suwon-si (KR); Kang-Young Kim, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/642,893

(22) Filed: Dec. 21, 2006

(30) Foreign Application Priority Data
Feb. 7, 2006 (KR) 2006-11856

(51) Int. Cl. C23G 1/00; B08B 3/00; B08B 7/00

(52) U.S. Cl. 134/2; 134/94.1; 134/95.1; 134/149; 134/151; 134/198; 134/34; 134/26; 134/33

(57) ABSTRACT

Embodiments of the invention provide a semiconductor wafer cleaning apparatus and a related method. In one embodiment, the invention provides a semiconductor wafer cleaning apparatus comprising a wafer stage adapted to support a wafer; a first cleaning unit adapted to spray a first cleaning solution onto the wafer to remove particles from the wafer, wherein the first cleaning solution prevents static electricity from being generated on the surface of the wafer; and a second cleaning unit adapted to provide a second cleaning solution onto the wafer and oscillate a quartz rod to remove particles from the wafer, wherein the second cleaning solution makes a surface of the wafer hydrophilic.

### BACKGROUND

1. Field of the Invention

Embodiments of the invention relate to an apparatus and method for fabricating a semiconductor device. In particular, embodiments of the invention relate to a wafer cleaning apparatus and a related method.

This application claims priority to Korean Patent Application No. 2006-11856, filed on Feb. 7, 2006, the subject matter of which is hereby incorporated by reference in its entirety.

2. Description of Related Art

As circuit patterns in semiconductor devices become smaller as the degree of integration of semiconductor devices increases, relatively small (i.e., fine) particles such as corpuscles, metal impurities, and the like have greater effects on yield in the manufacture of semiconductor devices and on the reliability of the semiconductor devices manufactured. Such particles are generally removed from a wafer using a wet cleaning process. In order to remove various target materials, such as corpuscles on a wafer, metal impurities, organic contaminants, and a surface film (e.g., a natural oxide coating or adsorbed molecules), one cleaning system is configured to perform a plurality of cleaning processes using a plurality of cleaning solutions. Figure (FIG.) 1 illustrates a typical example of such a cleaning system. The cleaning system of FIG. 1 is a spin scrubber including both a megasonic unit and a brush unit.

Referring to FIG. 1, a conventional spin scrubber 10 generally includes four process modules, which are process modules 11-14. A wafer transfer robot 15 can transfer a Wafer to and receive a wafer from any one of process modules 11-14. A process module 13 removes particles from a surface of a wafer W disposed on a wafer stage 13a using a megasonic unit 20 and a brush unit 30. A brush contacts a surface of wafer W when brush unit 30 drives the brush while wafer W rotates. Particles adsorbed on the surface of wafer W are physically removed using the brush. Simultaneously, megasonic unit 30 sprays deionized water (DIW), to which megasonic energy is added, onto the surface of wafer W to remove particles attached to the surface of wafer W. Process modules 11, 12, and 14 (i.e., the other process modules) are operated in the same manner as process module 13.

Since brush unit 30 uses physical friction between the brush and the wafer, it is important to maintain (i.e., manage) a gap between the brush and the wafer. However, a decrease in the size of semiconductor devices makes it difficult to maintain the gap, and the brush may contaminate the wafer if the brush and the wafer make direct contact. A pattern formed on the wafer may be damaged by megasonic unit 20 because of the pressure with which the DIW is discharged, and static electricity generated during a cleaning process using megasonic unit 20 makes it difficult to remove fine particles and may actually cause particles to be re-adsorbed onto the wafer.

### SUMMARY OF THE INVENTION

Embodiments of the invention provide a semiconductor wafer cleaning apparatus adapted to effectively remove particles from a semiconductor wafer without substantially damaging a pattern formed on the semiconductor wafer, and a related method. The semiconductor wafer cleaning apparatus comprises and the related method uses a spray unit adapted to prevent static electricity from being generated on the surface of the wafer instead of a megasonic unit used in a conventional spin scrubber, and a sonic unit instead of a brush unit, wherein the sonic unit uses a quartz rod.

In one embodiment, the invention provides a semiconductor wafer cleaning apparatus comprising a wafer stage adapted to support a wafer; a first cleaning unit adapted to spray a first cleaning solution onto the wafer to remove particles from the wafer, wherein the first cleaning solution prevents static electricity from being generated on the surface of the wafer; and a second cleaning unit adapted to provide a second cleaning solution onto the wafer and oscillate a quartz rod to remove particles from the wafer, wherein the second cleaning solution makes a surface of the wafer hydrophilic.

In another embodiment, the invention provides a semiconductor wafer cleaning apparatus comprising a plurality of cleaning process modules. Each cleaning process module comprises a wafer stage comprising a spin chuck rotatably supporting a wafer, and a cup surrounding the spin chuck; and a spray unit comprising a nozzle adapted to spray a first cleaning solution onto a surface of the wafer, and a pressurized-gas supply unit adapted to provide a pressurized gas to the nozzle to spray the first cleaning solution provided to the nozzle, wherein a static electricity preventing substance is dissolved in the first cleaning solution. Each cleaning process module further comprises a sonic unit comprising a quartz rod adapted to oscillate to transmit oscillation energy to a second cleaning solution, and a sonic oscillator adapted to generate sonic energy used to oscillate the quartz rod, wherein the sonic unit is adapted to provide a second cleaning solution comprising an alkali comprising hydroxyl onto the surface of the wafer.

In yet another embodiment, the invention provides a semiconductor wafer cleaning apparatus comprising a plurality of process modules. Each process module comprises a wafer stage adapted to rotatably support a wafer; a spray unit adapted to spray CO₂-dissolved DIW onto a surface of the wafer through a nozzle disposed at an end of a rotatable first arm by providing pressurized nitrogen to the nozzle; and a sonic unit adapted to oscillate a quartz rod disposed at an end of a rotatable second arm and adapted to transmit oscillation energy to diluted ammonia water disposed on the surface of the wafer to remove particles from the surface of the wafer.

In yet another embodiment, the invention provides a method for cleaning a semiconductor wafer comprising spraying CO₂-dissolved deionized water (DIW) onto a surface of a wafer, moving a quartz rod to a position relatively near a surface of the wafer, and oscillating the quartz rod while providing diluted ammonia water to the surface of the wafer.

### BRIEF DESCRIPTION OF THE DRAWINGS

Embodiments of the invention will be described herein with reference to the accompanying drawings in which like reference symbols indicate like or similar elements throughout. In the drawings:

FIG. 1 is a schematic block diagram of an example of a conventional semiconductor wafer cleaning system;

FIG. 2 is a schematic block diagram of a semiconductor wafer cleaning apparatus in accordance with an embodiment of the invention;

FIG. 3 is a schematic block diagram of a spray unit of the semiconductor wafer cleaning apparatus of FIG. 2 in accordance with an embodiment of the invention;

FIG. 4 is a schematic block diagram of a sonic unit of the semiconductor wafer cleaning apparatus of FIG. 2 in accordance with an embodiment of the invention;

FIG. 5 is a perspective view of a process module of the semiconductor wafer cleaning apparatus of FIG. 2 in accordance with an embodiment of the invention;

FIG. 6 is a graph showing particles removal rates in accordance with the type of cleaning solution used by a sonic unit; and,

FIG. 7 shows the results of cleaning wafers with a spray unit, a sonic unit, and a conventional megasonic unit, respectively.

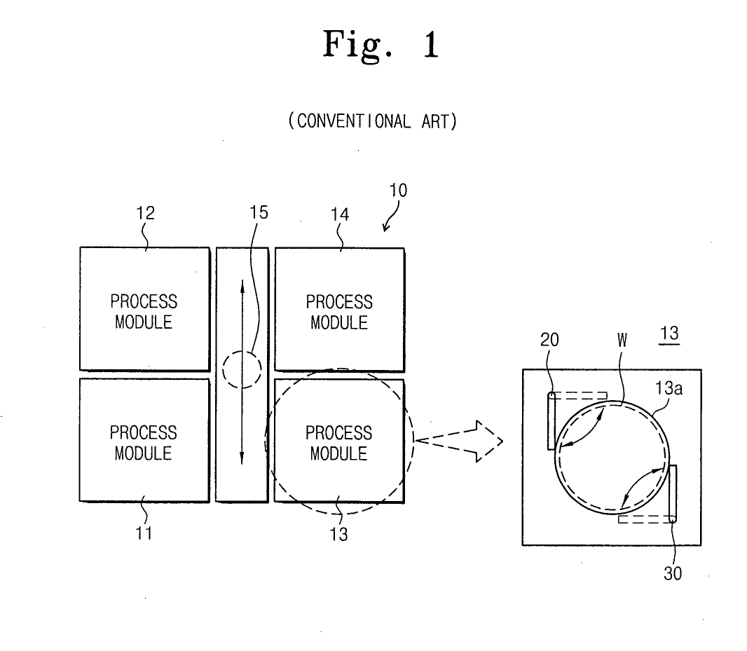

### DESCRIPTION OF EMBODIMENTS

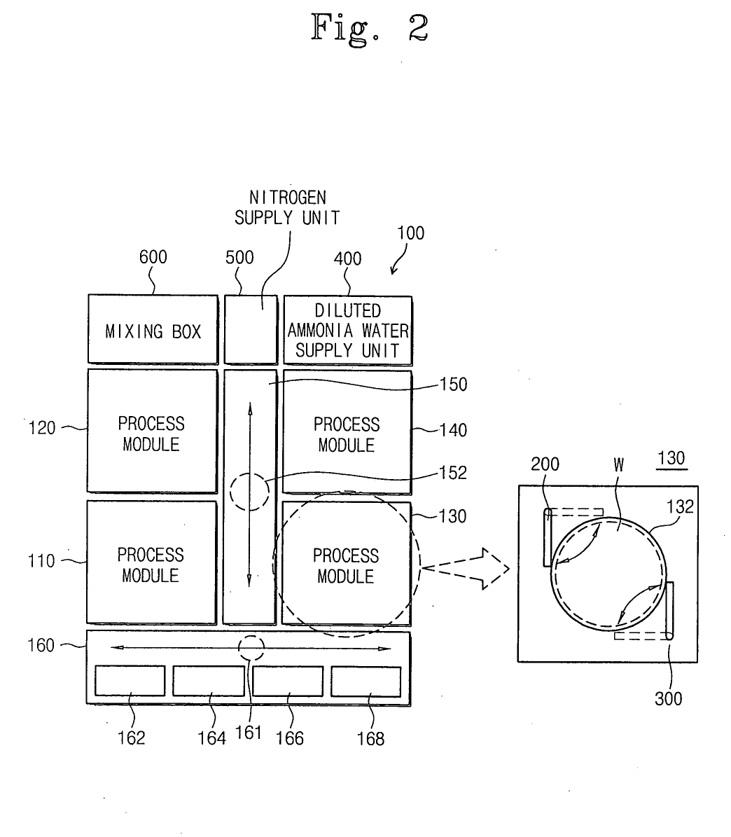

FIG. 2 is a schematic block diagram of a semiconductor wafer cleaning apparatus 100 in accordance with an embodiment of the invention.

Referring to FIG. 2, semiconductor wafer cleaning apparatus 100 comprises a plurality of process modules, each of which is adapted to perform at least one cleaning process for cleaning a semiconductor wafer. In the embodiment illustrated in FIG. 2, semiconductor wafer cleaning apparatus 100 comprises four process modules, which are process modules 110, 120, 130, and 140. Semiconductor wafer cleaning apparatus 100 also comprises a wafer transfer unit 150 adapted to transfer a wafer, and an indexing unit 160 through which a wafer is loaded into and unloaded from semiconductor wafer cleaning apparatus 100. A wafer to be cleaned is sequentially provided to indexing unit 160, wafer transfer unit 150, and then to one of process modules 110-140 (i.e., process modules 110, 120, 130, and 140). In contrast, a wafer on which a cleaning process has been performed in one of process modules 110-140 is sequentially transferred from the one of the process modules 110-140 in which the wafer cleaning process was performed to wafer transfer unit 150, and then to indexing unit 160. As used herein, a “cleaned wafer” is a wafer on which a cleaning process has been performed in one of process modules 110-140.

In the embodiment illustrated in FIG. 2, indexing unit 160 comprises four cassette stages, which are cassette stages 162, 164, 166, and 168, and comprises an indexing robot 161. Each of cassette stages 162, 164, 166, and 168 is adapted to receive a cassette containing a plurality of wafers. That is, a cassette containing a plurality of wafers may be loaded into any one of cassette stages 162, 164, 166, and 168. Also, a cassette containing cleaned wafers may be unloaded from the cassette stage of cassette stages 162, 164, 166, and 168 in which it is loaded. In addition, indexing robot 161 transfers wafers between wafer transfer unit 150 and each of cassette stage 162, 164, 166, and 168.

Wafer transfer unit 150 comprises a wafer transfer robot 152 that is adapted move within wafer transfer unit 150. Wafer transfer robot 152 is also adapted to receive a wafer to be cleaned from indexing robot 161 and provide the received wafer to one of process modules 110-140. In addition, wafer transfer robot 152 is adapted to receive a cleaned wafer from any one of process modules 110-140 and provide the cleaned wafer to indexing robot 161.

Process module 130 will now be described in some additional detail with reference to FIG. 2. Process modules 110, 120, and 140 are substantially the same as process module 130, so all description of process module 130 made herein may also apply to process modules 110, 120, and 140. Referring to FIG. 2, process module 130 generally comprises two wafer cleaning units, which are a spray unit 200 and a sonic unit 300. Spray unit 200 is adapted to spray a cleaning solution (for example, deionized water (DIW)) onto a wafer W mounted on a wafer stage 132 to remove particles from a surface of wafer W. Sonic unit 300 is adapted to move a rod formed from quartz near to the surface of wafer W onto which a cleaning solution has been sprayed and oscillate the quartz rod with sonic energy to thereby agitate the cleaning solution to remove particles from the surface of wafer W. Spray unit 200 and sonic unit 300 are each adapted to rotate within process module 130 (see the corresponding arrows in FIG. 2). That is, spray unit 200 and sonic unit 300 are each movably installed within process module 130.

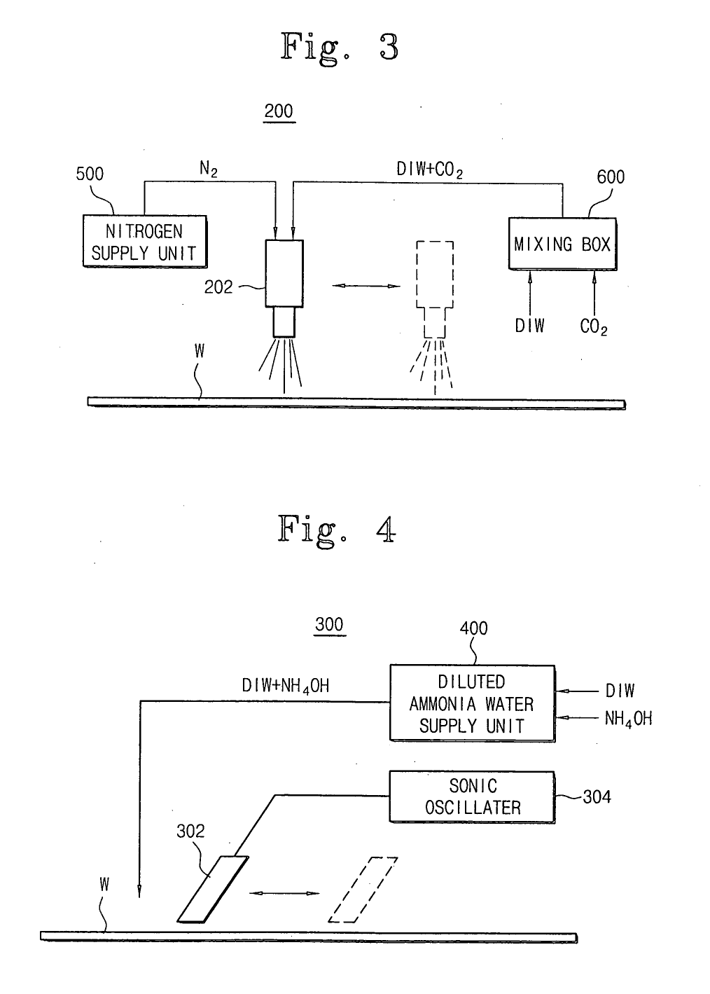

FIG. 3 is a schematic block diagram of spray unit 200 of semiconductor wafer cleaning apparatus 100 of FIG. 2 in accordance with an embodiment of the invention.

Referring to FIG. 3, spray unit 200 comprises a moveable nozzle 202. In spray unit 200, a first cleaning solution is provided to nozzle 202 and is sprayed onto a wafer W through nozzle 202. In the embodiment of spray unit 200 illustrated in FIG. 3, the first cleaning solution is sprayed as pressurized nitrogen is provided to nozzle 202. In addition, a nitrogen supply unit 500 (i.e., a pressurized-gas supply unit) of semiconductor wafer cleaning apparatus 100 is adapted to provide the pressurized nitrogen to nozzle 202. When the first cleaning solution is pressurized and thus sprayed at a relatively high speed, friction between the first cleaning solution and wafer W generates static electricity at a surface of wafer W. The static electricity may damage a circuit pattern formed on wafer W and may also cause particles to be re-adsorbed onto wafer W.

In the embodiment illustrated in FIG. 3, DIW in which carbon dioxide (CO₂) (i.e., a static electricity preventing substance) is dissolved, and which therefore has reduced resistance, is used as the first cleaning solution to prevent the generation of static electricity at a surface of wafer W. When CO₂ reacts with DIW (H₂O), H+ and HCO₃− ions are generated. DIW in which carbon dioxide (CO₂) is dissolved (hereinafter referred to as CO₂-dissolved DIW) acts as ionic water that neutralizes static electricity and thus prevents the surface of wafer W from becoming electrically charged. The CO₂-dissolved DIW is made in a mixing box 600 of semiconductor wafer cleaning apparatus 100 and is provided to nozzle 202. Mixing box 600 may be designed to provide the CO₂-dissolved DIW not only to process module 130 but also to process modules 110, 120, and 140 (see FIG. 2). Similarly, nitrogen supply unit 500 may be designed to provide pressurized nitrogen not only to process module 130, but also to process modules 110, 120, and 140 (see FIG. 2). As used herein, a “static electricity preventing substance” is a substance that may be dissolved in DIW or a similar solvent to produce a cleaning solution that may be used by spray unit 200 to prevent the generation of static electricity at the surface of wafer W.

FIG. 4 is a schematic block diagram of sonic unit 300 of semiconductor wafer cleaning apparatus 100 of FIG. 2 in accordance with an embodiment of the invention.

Referring to FIG. 4, sonic unit 300 continuously provides a second cleaning solution to wafer W and oscillates a quartz rod 302 near a surface of wafer W. Oscillation energy is transmitted to the cleaning solution by oscillating quartz rod 302 to remove particles from the surface of wafer W. Energy required to oscillate the quartz rod 302 is generated and provided to quartz rod 302 by a sonic oscillator 304.

DIW is generally used as the second cleaning solution. When the surface of wafer W becomes hydrophobic, liquid drops are formed on the surface of wafer W by surface tension of the DIW. Corpuscles are readily gathered in the liquid drops. The corpuscles gathered in the liquid crystal drop are easily re-adsorbed on the surface of wafer W, thereby contaminating wafer W. Therefore, the surface of wafer W is preferably made to be hydrophilic, using hydroxyl (OH—), to prevent re-adsorption of the corpuscles on wafer W. Therefore, a mixture of DIW and alkali containing OH— is preferably used as the second cleaning solution. For example, a mixture of ammonia water (NH₄OH) and DIW may be used as the second cleaning solution.

When diluted ammonia water, obtained by mixing ammonia water (NH₄OH) and DIW at a volume ratio of ammonia water to DIW that is within a range of about 1:1000 to 100:1000, is used as the second cleaning solution, the surface of wafer W may be effectively cleaned without damaging a circuit pattern of wafer W. That is, the surface of wafer W is made to be hydrophilic and re-adsorption of particles on the wafer may be substantially prevented by using the mixture of NH₄OH and DIW as the second cleaning solution. Also, corrosion of a metal film included in the circuit pattern of wafer W may be prevented when using the diluted ammonia water as the second cleaning solution. As used herein, a “volume ratio” of two substances is the ratio of the volume of the first substance to the volume of the second substance.

A diluted ammonia supply unit 400 (i.e., a cleaning solution supply unit 400) of semiconductor wafer cleaning apparatus 100 provides the second cleaning solution obtained by mixing NH₄OH and DIW to sonic unit 300. Diluted ammonia supply unit 400 may be designed to supply diluted ammonia water not only to the process module 130, but also to process modules 110, 120, and 140 (see FIG. 2).

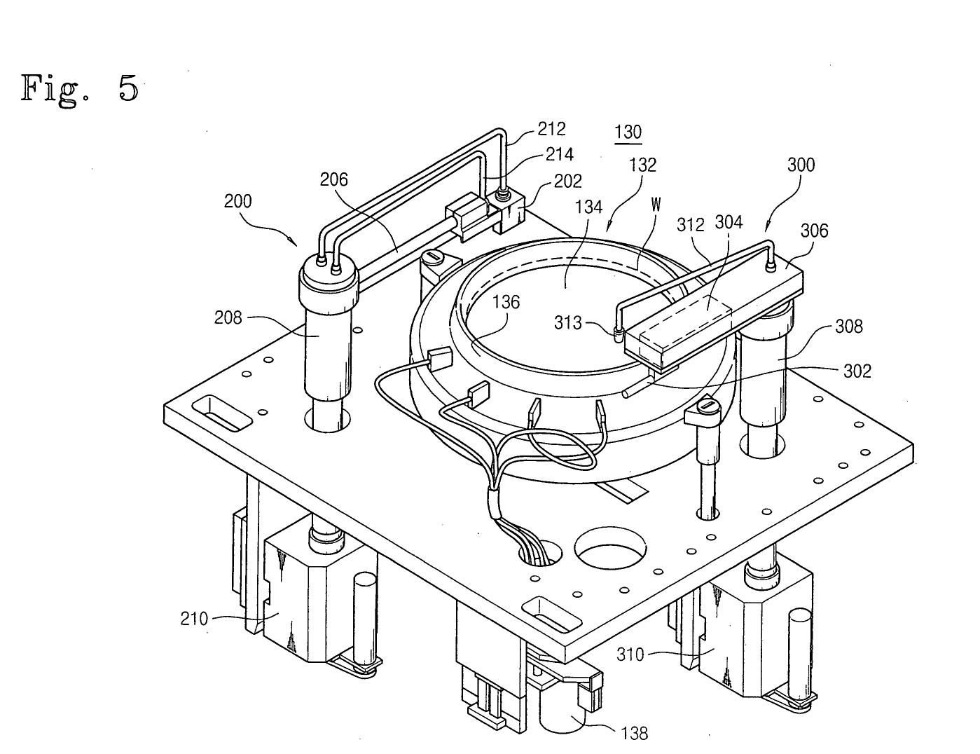

FIG. 5 is a perspective view of a process module 130 of semiconductor wafer cleaning apparatus 100 of FIG. 2 in accordance with an embodiment of the invention. Though FIG. 5 illustrates process module 130, process modules 110, 120, and 140 may be substantially the same as process module 130, as illustrated in FIG. 5.

Referring to FIG. 5, process module 130 comprises a wafer stage 132 comprising a spin chuck 134 and a cup 136 surrounding the spin chuck 134. Spin chuck 134 is adapted to rotatably support a wafer W and hold wafer W in a substantially horizontal state, and a motor 138 is adapted to rotate spin chuck 134. During a cleaning process, a cleaning solution is provided to a surface of wafer W, which is being rotated by spin chuck 134, and cup 136 surrounds wafer W and prevents the cleaning solution from being undesirably scattered.

Process module 130 further comprises a spray unit 200. Spray unit 200 comprises a shaft 208 rotatably supporting an arm 206 extending substantially horizontally from an upper end of shaft 208. A nozzle 202 adapted to spray a cleaning solution at a high speed is disposed at a front end of arm 206. In addition, shaft 208 is combined with a driver 210 and, together, shaft 208 and driver 210 are adapted to rotate (i.e., pivot), raise, and lower arm 206. Therefore, nozzle 202 can be rotated about shaft 208 and can be raised and lowered. Additionally, a line 212 is adapted to provide CO₂-dissolved DIW to nozzle 202, a line 214 is adapted to provide pressurized nitrogen to nozzle 202, and lines 212 and 214 are combined in nozzle 202. The cleaning solution (i.e., the CO₂-dissolved DIW) is sprayed from nozzle 202 onto wafer W at a high speed by the pressurized nitrogen. In the embodiment illustrated in FIG. 5, a first end of line 212 is connected to nozzle 202, a second end of line 212 is connected to an upper end of shaft 208, a first end of line 214 is connected to nozzle 202, and a second end of line 214 is connected to the upper end of shaft 208.

Process module 130 also comprises a sonic unit 300. Sonic unit 300 comprises a shaft 308 rotatably supporting an arm 306 extending substantially horizontally from an upper end of shaft 308. In addition, sonic unit 300 comprises a quartz rod 302 disposed at a front end of arm 306. Shaft 308 is combined with a driver 301 and, together, shaft 308 and driver 310 are adapted to rotate (i.e., pivot), raise, and lower arm 306. Thus, the quartz rod 302 can be rotated about shaft 308 and can be raised and lowered. In the embodiment illustrated in FIG. 5, sonic unit 300 comprises a sonic oscillator 304 mounted in arm 306. Sonic unit 300 further comprises a line 312 through which sonic unit 300 provides diluted ammonia water to the surface of wafer W. A nozzle 313 is disposed at a first end of line 312, and a second end of line 312 is connected to arm 306. Line 312 may be adapted to pivot around shaft 308 separately from arm 306.

A cleaning operation, in accordance with an embodiment of the invention, of semiconductor wafer cleaning apparatus 100 as described above with reference to FIGS. 2 to 5, will now be described.

First, a wafer W to be cleaned is loaded into a cassette and the cassette is then loaded onto one of cassette stages 162, 164, 166, and 168 of indexing unit 160. Indexing robot 161 then removes wafer W from the cassette and provides wafer W to wafer transfer robot 152. Wafer transfer robot 152 then provides wafer W to one of process modules 110-140. For convenience of description, it will be assumed that wafer transfer robot 152 provided wafer W to process module 130. After wafer W is provided to process module 130, spin chuck 134 of wafer stage 132 holds wafer W to spin chuck 134. Wafer W, which is held by to spin chuck 134, is rotated during a cleaning operation. The cleaning operation is performed using spray unit 200 and sonic unit 300 of process module 130. In the cleaning operation, either one of spray unit 200 and sonic unit 300 can be used first, and which one is used first may be determined arbitrarily. Spray unit 200 may be used in one cleaning process of the cleaning operation and sonic unit 300 may be used in another cleaning process of the cleaning operation.

A cleaning process that uses spray unit 200 will now be described. CO₂ is dissolved in DIW in a mixing box 600. The CO₂-dissovled DIW is then provided to nozzle 202 through line 212, and pressurized nitrogen is supplied to nozzle 202 from supply unit 500 through line 214 simultaneously. The CO₂-dissovled DIW is sprayed through nozzle 202 by the pressurized nitrogen and is sprayed onto the surface of wafer W while wafer W is being rotated on wafer stage 132. Thus, particles are removed from the surface of wafer W by the DIW, which is being sprayed with a strong force. The CO₂-dissovled DIW prevents static electricity from being generated at the surface of wafer W so that the particles are not re-adsorbed onto wafer W.

A cleaning process that uses sonic unit 300 will now be described. Diluted ammonia water supply unit 400 mixes ammonia water (NH₄OH) and DIW at a volume ratio of ammonia water to DIW that is within a range of 1:1000 to 100:1000 to produce diluted ammonia water. Diluted ammonia water supply unit 400 then provides the diluted ammonia water to sonic unit 300. Sonic unit 300 then provides the diluted ammonia water to nozzle 313 through line 312 and sprays the diluted ammonia water onto the surface of wafer W. Sonic unit 300 provides diluted ammonia water to the surface of wafer W while wafer W is being rotated on wafer stage 132, and the diluted ammonia water makes the surface of wafer W hydrophilic. In addition, while the diluted ammonia water is being continuously supplied onto the surface of wafer W, quartz rod 302 oscillates about 1 to 2 mm away from the surface of wafer W. The oscillating quartz rod 302 transmits oscillation energy to the diluted ammonia water. Sonic oscillator 304 generates the energy required to oscillate quartz rod 302. Using the diluted ammonia water may contribute to removing particles from the surface of the wafer without corroding a metal film formed on the surface of wafer W.

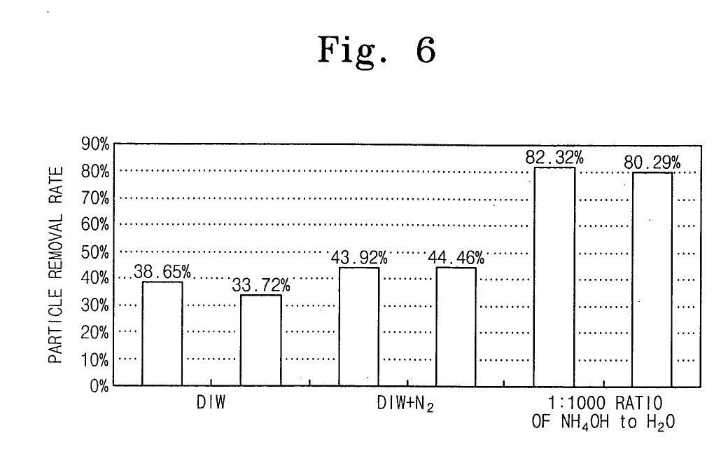

FIG. 6 is a graph showing particle removal rates in accordance with the type of cleaning solution used by sonic unit 300. Referring to FIG. 6, when cleaning processes using sonic unit 300 are performed while varying the type of cleaning solution used and holding other cleaning conditions constant, particle-removing rates differ in accordance with the type of cleaning solution used. For example, when DIW was used as the cleaning solution, particle removal rates of 38.65% and 33.72% were obtained. When a fluid comprising a mixture of DIW and nitrogen (N₂) was used as the cleaning solution, particle removal rates of 43.92% and 44.46% were obtained. However, when diluted ammonia water obtained by mixing NH₄OH and H₂O at a volume ratio of 1:1000 was used as the cleaning solution, relatively high particle removal rates of 82.32% and 80.29% were obtained. Thus, of the preceding cleaning solutions (i.e., the cleaning solutions discussed with reference to FIG. 6), the best particle removal rate can be achieved when using the diluted ammonia water as the cleaning solution.

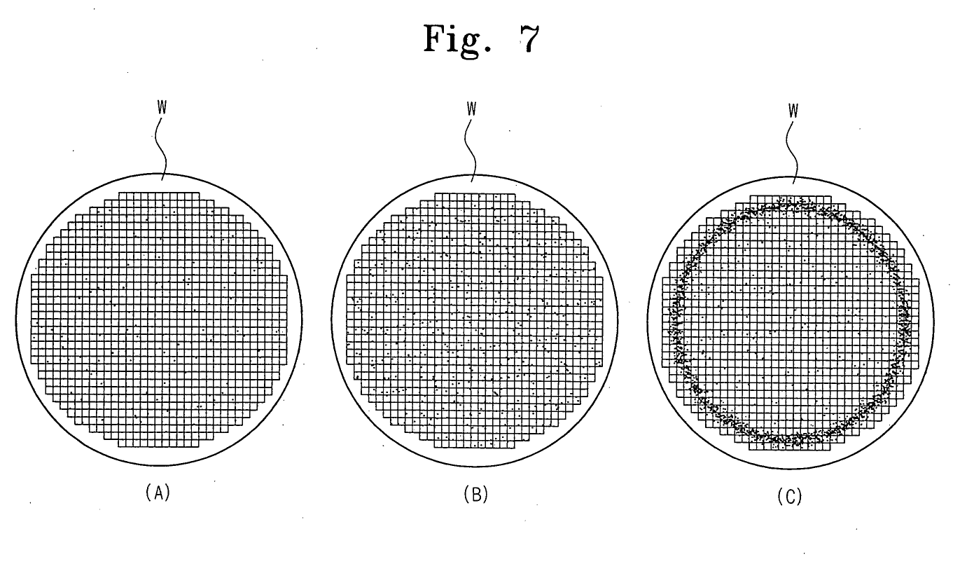

FIG. 7 shows the results of cleaning wafers W with a spray unit, a sonic unit, and a conventional megasonic unit, respectively. In FIG. 7, wafer W of part (A) was cleaned using a spray unit, wafer W of part (B) was cleaned using a sonic unit, and wafer W of part (C) was cleaned using a conventional megasonic unit. As illustrated in part (C), a pattern printed on an edge of wafer W of part (C) was damaged by the cleaning process using the megasonic unit. However, as illustrated in parts (A) and (B), the patterns printed on wafers W of parts (A) and (B) suffered relatively little damage.

As described previously, a semiconductor wafer cleaning apparatus, in accordance with an embodiment of the invention, comprises a spray unit adapted to spray CO₂-dissolved DIW onto a wafer, and a sonic unit adapted to oscillate a quartz rod with sonic energy and use diluted ammonia water as a cleaning solution. The semiconductor wafer cleaning apparatus may effectively remove particles from a surface of the wafer while causing less damage to a pattern printed on the wafer and while re-adsorption fewer particles onto the wafer. Thus, yield may be improved.

Although embodiments of the invention have been described herein, those skilled in the art may modify the embodiments without departing from the scope of the invention as defined by the accompanying claims.

What is claimed is:

1. A semiconductor wafer cleaning apparatus comprising:
a wafer stage adapted to support a wafer;
a first cleaning unit spraying a first cleaning solution onto the wafer, wherein the first cleaning solution prevents static electricity from being generated on the surface of the wafer; and,
a second cleaning unit providing a second cleaning solution onto the wafer while oscillating a quartz rod to remove particles from the wafer, wherein the second cleaning solution makes a surface of the wafer hydrophilic.

2. The apparatus of claim 1, wherein the first cleaning solution comprises deionized water (DIW) with dissolved carbon dioxide (CO₂).

3. The apparatus of claim 2, wherein the first cleaning unit provides pressurized nitrogen to the first cleaning solution.

4. The apparatus of claim 1, wherein the second cleaning solution comprises alkali containing hydroxyl.

5. The apparatus of claim 4, wherein the alkali containing hydroxyl is ammonia water.

6. The apparatus of claim 5, wherein the second cleaning solution comprises ammonia water and DIW mixed respectively in a volume ratio having a range of between about 1:1000 to 100:1000.

7. A semiconductor wafer cleaning apparatus comprising:
a plurality of cleaning process modules, each comprising:
a wafer stage comprising a spin chuck rotatably supporting a wafer, and a cup surrounding the spin chuck;
a spray unit comprising a nozzle adapted to spray a first cleaning solution having a dissolved static electricity preventing substance onto a surface of the wafer, and a pressurized-gas supply unit adapted to provide a pressurized gas to the nozzle; and,
a sonic unit comprising an oscillating quartz rod communicating oscillation energy to a second cleaning solution and providing a second cleaning solution mixed with alkali containing hydroxyl onto the surface of the wafer.

8. The apparatus of claim 7, further comprising a mixing box adapted to provide the first cleaning solution to each cleaning process module.

9. The apparatus of claim 8, wherein the mixing box generates the first cleaning solution by dissolving the static electricity preventing substance in deionized water (DIW).

10. The apparatus of claim 9, wherein the static electricity preventing substance is CO₂.

11. The apparatus of claim 7, further comprising a cleaning solution supply unit adapted to supply the second cleaning solution to each cleaning process module.

12. The apparatus of claim 11, wherein the cleaning solution supply unit is adapted to generate the second cleaning solution by diluting the alkali containing hydroxyl with DIW.

13. The apparatus of claim 12, wherein the alkali containing hydroxyl is ammonia water.

14. The apparatus of claim 12, wherein the second cleaning solution is comprises ammonia water and DIW mixed respectively in a volume ratio having a range of between about 1:1000 to 100:1000.

15. A semiconductor wafer cleaning apparatus comprising:
a plurality of process modules, wherein each process module comprises:
a wafer stage adapted to rotatably support a wafer;
a spray unit adapted to spray CO₂-dissolved deionized water (DIW) onto a surface of the wafer through a nozzle disposed at an end of a rotatable first arm by providing pressurized nitrogen to the nozzle; and,
a sonic unit adapted to oscillate a quartz rod disposed at an end of a rotatable second arm and adapted to transmit oscillation energy to diluted ammonia water disposed on the surface of the wafer to remove particles from the surface of the wafer.

16. The apparatus of claim 15, wherein the spray unit comprises:
a first shaft adapted to rotatably support the first arm; and,
a first driver adapted to rotate, raise, and lower the first shaft.

17. The apparatus of claim 15, wherein the sonic unit comprises:
a second shaft rotatably supporting the second arm;
a second driver adapted to rotate, raise, and lower the second shaft; and,
a nozzle adapted to provide the diluted ammonia water to the surface of the wafer.

18. The apparatus of claim 15, further comprising a mixing box adapted to provide the CO₂-dissolved DIW to each process module.

19. The apparatus of claim 15, further comprising a cleaning solution supply unit adapted to supply the diluted ammonia water to each process module.

20. The apparatus of claim 15, further comprising a nitrogen supply unit adapted to provide the pressurized nitrogen to each process module.

21. The apparatus of claim 15, wherein the wafer stage comprises:
a spin chuck adapted to support the wafer and hold the wafer to the spin chuck; and,
a cup disposed surrounding the spin chuck.

22. A method for cleaning a semiconductor wafer comprising:
spraying CO₂-dissolved deionized water (DIW) onto a surface of a wafer;
moving a quartz rod to into a position proximate the wafer; and,
oscillating the quartz rod while providing diluted ammonia water onto the surface of the wafer.

23. The method of claim 22, further comprising:
rotating the wafer while spraying the CO₂-dissolved DIW onto the surface of the wafer; or,
rotating the wafer while oscillating the quartz rod while providing the diluted ammonia water to the surface of the wafer.

24. The method of claim 22, further comprising:
rotating the wafer while spraying the CO₂-dissolved DIW onto the surface of the wafer; and,
rotating the wafer while oscillating the quartz rod while providing the diluted ammonia water to the surface of the wafer.

25. The method of claim 22, wherein the spraying of the CO₂-dissolved DIW onto the surface of the wafer comprises:
providing the CO₂-dissolved DIW to the nozzle while also providing pressurized nitrogen to the nozzle to spray the CO₂-dissolved DIW onto the surface of the wafer.

26. The method of claim 25, wherein providing the diluted ammonia water comprises diluting ammonia water with DIW to obtain a volume ratio of ammonia water to DIW in a range of between about 1:1000 to 100:1000.
